(19) United States
(12) Patent Application Publication
(10) Pub. No.: US 2019/0220174 A1
(43) Pub. Date: Jul. 18, 2019

(54) METHODS, SYSTEMS, AND APPARATUSES FOR FACILITATING CUSTOMIZABLE DISPLAY OF IMAGES ON A SURFACE OF AN ARTICLE

(71) Applicant: Kaleem Akhtar Rana, Anahieam, CA (US)

(72) Inventor: Kaleem Akhtar Rana, Anahieam, CA (US)

(21) Appl. No.: 16/245,013

(22) Filed: Jan. 10, 2019

Related U.S. Application Data
(60) Provisional application No. 62/618,757, filed on Jan. 18, 2018.

(51) Int. Cl. G06F 3/0484; G06F 1/3234; G06F 3/0481; G06F 21/31; H04L 12/18

(52) U.S. Cl. CPC G06F 3/04845; G06F 1/3265; H04L 12/189; G06F 21/31; G06F 3/04817

(57) ABSTRACT

A smart apparatus for facilitating customizable display of images on a surface of an article is disclosed. The smart apparatus may include a display device including a plurality of display elements arranged according to a predetermined pattern. Further, the smart apparatus may include a processor configured for processing a display data, and generating a plurality of light activation signals based on the processing. Further, the smart apparatus may include a receiver communicatively coupled to the processor, configured for receiving the display data from a user device associated with the article. Further, the smart apparatus may include a storage device for storing one or more of the display data and the plurality of light activation signals, communicatively coupled to the processor. Further, the smart apparatus may include a power source electrically coupled to each of the display device, the processor, the receiver and the storage device configured for providing electrical energy.

The current application claims a priority to the U.S. Provisional Patent application Ser. No. 62/618,757 filed on Jan. 18, 2018.

### FIELD OF THE INVENTION

The present disclosure relates generally to electronic devices. More specifically, the present disclosure describes methods and systems, and apparatuses for facilitating customizable display of images on a surface of an article.

### BACKGROUND OF THE INVENTION

Currently, there are no products in the market space that may allow consumers to customize shoes, clothing and other products with the LEDs. The existing LED wearable products available are not smart complaint, app controlled, nor do they allow customized color, theme, and pixel-level control of LEDs used for customizing objects.

Further, existing LED wearable products for customizing objects may also not be accessed over cloud, and do not allow sharing of customized designs with users including friends and family.

Therefore, there is a need for improved methods and systems, and apparatuses for facilitating customizable display of images on a surface of an article that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a smart apparatus for facilitating customizable display of images on a surface of an article is disclosed. The smart apparatus may include a display device configured to be disposed on the surface of the article. Further, the display device may include a plurality of display elements arranged according to a predetermined pattern. Further, the plurality of display elements may be configured for generating a plurality of light outputs based on a plurality of light activation signals. Further, the smart apparatus may include a processor communicatively coupled to the display device. Further, the processor may be configured for processing a display data. Further, the processor may be configured for generating the plurality of light activation signals based on the processing. Further, the smart apparatus may include a receiver communicatively coupled to the processor. Further, the receiver may be configured for receiving the display data from at least one user device associated with the article over a wireless communication channel. Further, the smart apparatus may include a storage device communicatively coupled to the processor. Further, the storage device may be configured for storing one or more of the display data and the plurality of light activation signals. Further, the smart apparatus may include a power source configured for providing electrical energy. Further, the power source may be electrically coupled to each of the display device, the processor, the receiver and the storage device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 shows a block diagram of a smart apparatus for facilitating customizable display of images on a surface of an article, in accordance with some embodiments.

FIG. 3 shows a smart article configured for providing a customizable display of light output, in accordance with some embodiments.

FIG. 4 shows a method 400 of facilitating customized display of images on a smart article, in accordance with some embodiments.

FIG. 5 shows a flowchart of a method to perform a first authentication, in accordance with some embodiments.

FIG. 6 shows a flowchart of a method to perform a second authentication, in accordance with some embodiments.

FIG. 7 shows a flowchart of a method to transmit a feedback to a user device, in accordance with some embodiments.

FIG. 8 shows a flowchart of a method to generate reward data, in accordance with some embodiments.

FIG. 9 shows a flowchart of a method to generate a customization interface, in accordance with some embodiments.

FIG. 10 shows a flowchart of a method to dispose a plurality of display elements onto a smart article, in accordance with some embodiments.

FIG. 11 shows an LED panel in connection with a user device over Wi-Fi, in accordance with some embodiments.

FIG. 12 shows an LED panel in connection with a user device over a short-range communication network, in accordance with some embodiments.

FIG. 13 shows a plurality of LED panels of different visual designs, in accordance with some embodiments.

FIG. 14 shows an exemplary embodiment of the user interface of the RockMe app, in accordance with some embodiments.

FIG. 15 shows an exemplary user interface of the RockMe™ application for iOS® that may allow a user to connect to a smart apparatus, in accordance with some embodiments.

FIG. 16 shows an exemplary user interface 1600 of the RockMe™ application for Android® that may allow a user to connect to a smart apparatus, in accordance with some embodiments.

FIG. 17 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of customizable display of images on a surface of an article, embodiments of the present disclosure are not limited to use only in this context.

Overview:

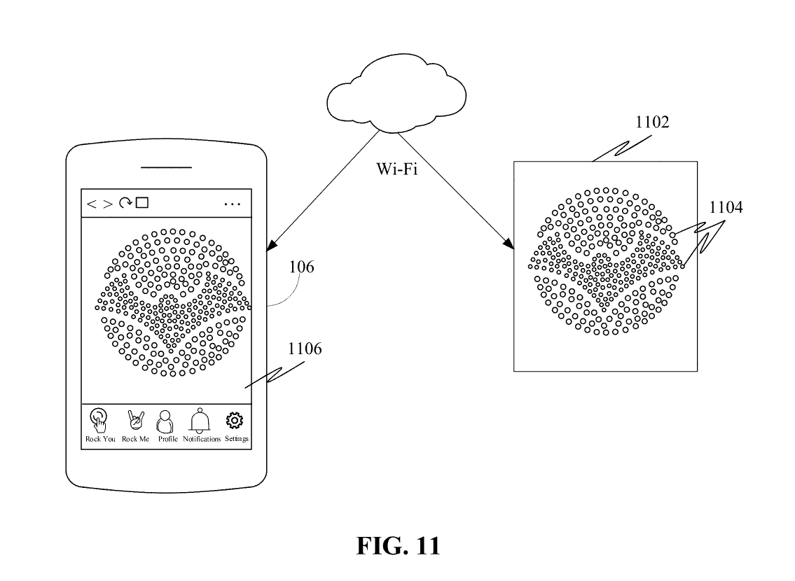

The present disclosure describes a smart apparatus comprising uniquely defined LED panels, such as LED panel 102, as shown in FIG. 11 that may be used with clothing, shoes, heels, bags, caps, hats, belts, lingerie, jewelry, skateboards, cycles and for event decorations. In an instance, the smart apparatus may be called as RockMe™ gadget and may include flexible\non-flexible LED panels. Further, the LED panel 1102 may include uniquely defined LED pixels 1104 which may be customized and controlled individually by a user using a user interface 1106 through a user device, such as a mobile device 106 (as shown in FIG. 11). Further, the user may also use the user interface 1106 to enable a dancing lights feature to the LED panel 1102 as per taste or mood, wherein the LED pixels 1104 may switch on or off as defined. Further, the user may also enable smart alerts and reminders like weather alerts, speed alerts, any personal message, etc. using the LED panel 1102. Further, the LED panel 1102 may be controlled from anywhere in the world by using a RockMe™ app installed on the mobile device 106 through the user interface 1106. Further, a user of the user interface 1106 may modify and customize gadget pixel themes (such as flash, colors, subjective/relative indication of intensity and so on of LED pixels 1104) and share the gadget pixel themes with other users of the user interface 1106. Further, if users may be able to sell the gadget pixel themes to one or more users in exchange for RockMe™ Coins (Virtual Money) equivalent to real currency or cryptocurrency.

Further, if the user wants to update color themes in the LED panel 1102 remotely from anywhere in the world, the user may connect the LED panel 1102 via WIFI. The user may provide WIFI credentials through the user interface 1106 to which may be updated in a RockMe™ Controller library associated with the LED panel 1102. The user may add many WIFI connections to the LED panel 1102. Further, the strongest WIFI signal from an available list of WIFI connections already added to the RockMe™ Controller library and may be connected to automatically. Further, once the LED panel 1102 connects to WIFI, the RockMe™ app may communicate with the LED panel 1102 over the cloud to update color themes which the user may select from an available list of themes in the RockMe™ app through the user interface 1106.

Further, if the user does not have WIFI, the user may connect the LED panel 1102 to the cloud using your cellular data network or hotspot, and may switch to any available mode of connection using the user interface 1106.

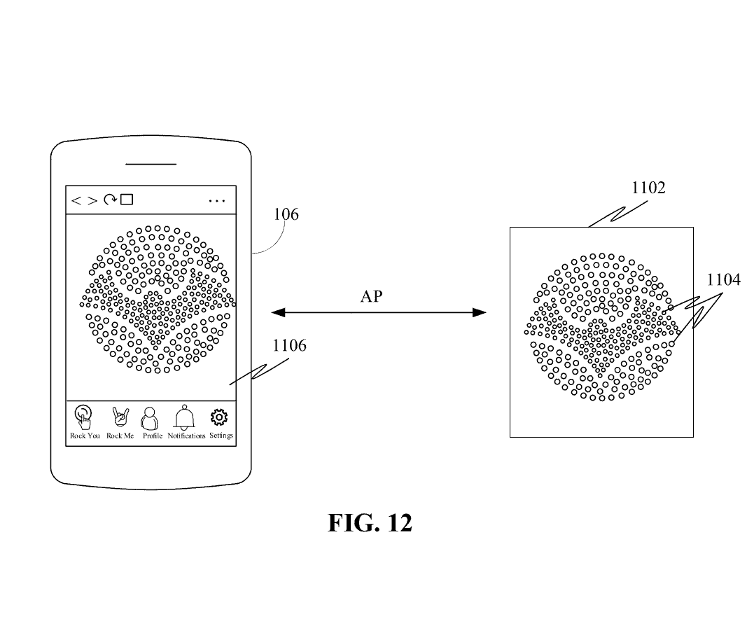

Further, if the user does not have WIFI access, the user may still control the LED panel 1102 using an AP mode where the user may directly connect to the LED panel 1102 using RockMe™ app over a short-range communication channel, such as Bluetooth, ZigBee, etc. and can update the LED panel 1102 directly without WIFI or broadband network, as shown in FIG. 12.

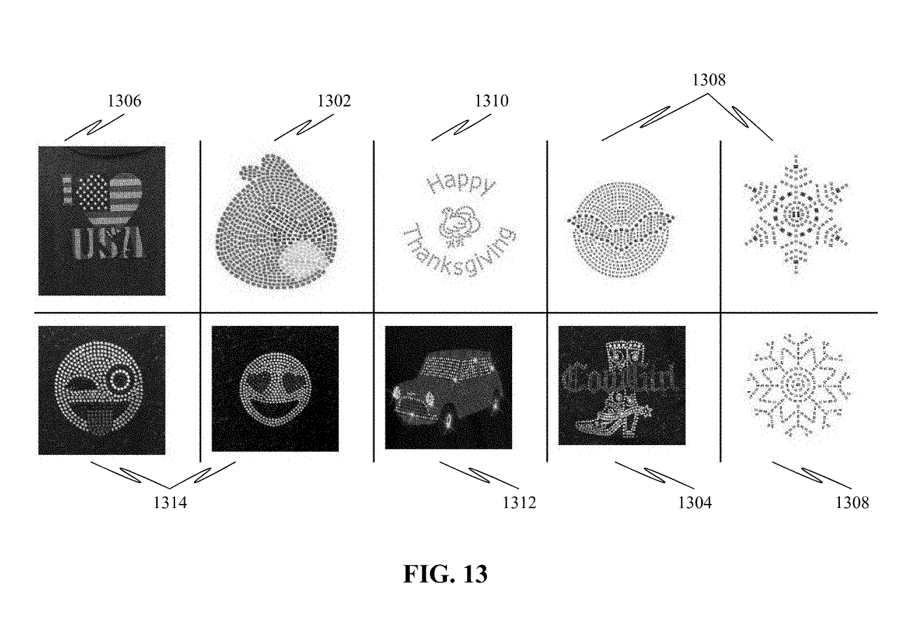

Further, the flexible or non-flexible LED panel 1102 may be based, and may include a design corresponding to a character 1302, a slogan 1304, a message 1306, uniquely defined patterns 1308, and may be designed for any event or occasion such as Thanksgiving 1310, corresponding to objects such as a car 1312, emoticons 1314, and so on, as shown in FIG. 13. Further, the LED panel 1102 may be applied and integrated with objects including skateboards, bicycle, motorcycles, helmets, jackets, t-shirts, hoodies, gloves, hats, caps, school bags, handbags, jewelry, shoes, sandals, heels, wearables, and so on.

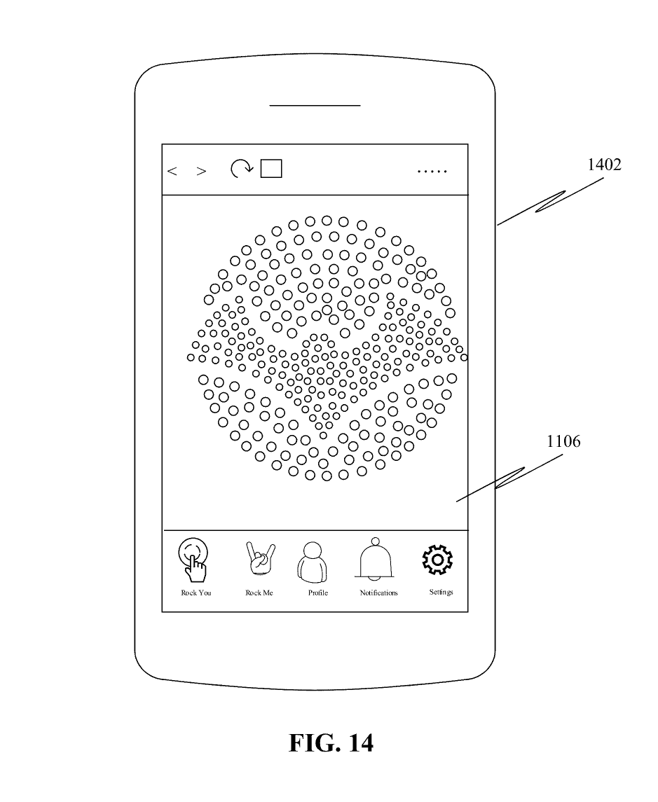

FIG. 14 shows an exemplary embodiment of the user interface 1106 of the RockMe™ app. The RockMe™ app may be installed on a user device, such as a smartphone 1402. The user interface 1106 may include one or more options that may be used by a user. For instance, the user interface 1106 may include an add gadget option that may enable a user to connect one or more LED panels, such as the LED panel 1102 to the RockMe™ app, and control and customize the one or more LED panels by controlling flashes, colors, subjective/relative indication of intensity and so on of LED pixels in the one or more LED panels, such as through available artworks (gadget pixel themes created by users) either available free or from a RockMe™ premium artwork gallery. Further, the user interface 1106 may allow the user to share control of the one or more LED panels with one or more users through the RockMe™ app. Sharing control may allow the one or more users to remotely customize the one or more LED panels with artworks.

Further, the RockMe™ app may also allow the user to design artworks for any LED panel through the user interface 1106. The user may be able to define each LED pixel of the LED panels and describe flashes, colors, subjective/relative indication of intensity and so on of LED pixels in the one or more LED panels. Further, the created artworks may be saved to a private gallery, may be shared or sold to one or more friends, or may be transmitted to a public gallery for sale, whereupon one or more users may be able to comment, like, and share the artwork, leading to an increase in a price of the artwork. Further, the user may be able to receive monetary compensation for the artwork, such as in the form of RockMe™ coins which may be cashed out with supported cryptocurrencies or real currency.

Further, the user may earn money and may get paid in cryptocurrency from RockMe™ L.L.C. The user may, for instance, make up to $0.001 US Cent per RockMe coin. After collecting a certain number of RockMe™ coins, the user may redeem RockMe™ coins with cryptocurrencies.

Further, the RockMe™ app and the user interface 1106 may be available in multiple languages.

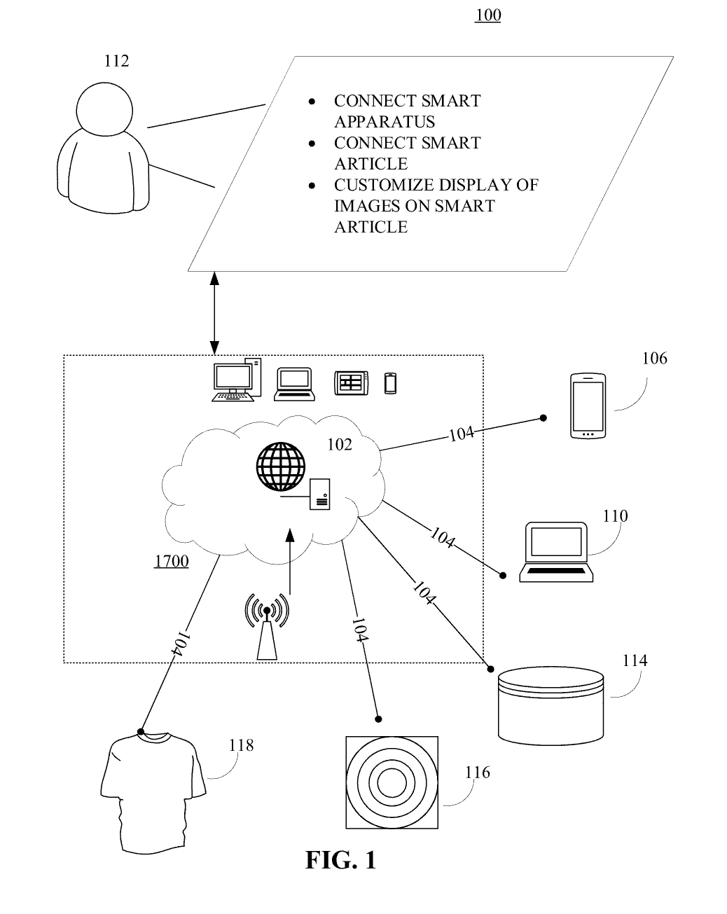

FIG. 1 is an illustration of an online platform 100 consistent with various embodiments of the present disclosure. By way of non-limiting example, the online platform 100 to facilitate customizable display of images on a surface of an article may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, sensors 116, actuators (not shown) and a smart article 118 over a communication network 104, such as, but not limited to, the Internet. Further, users of the online platform 100 may include relevant parties such as, but not limited to, end users, artists, designers, and administrators. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1700.

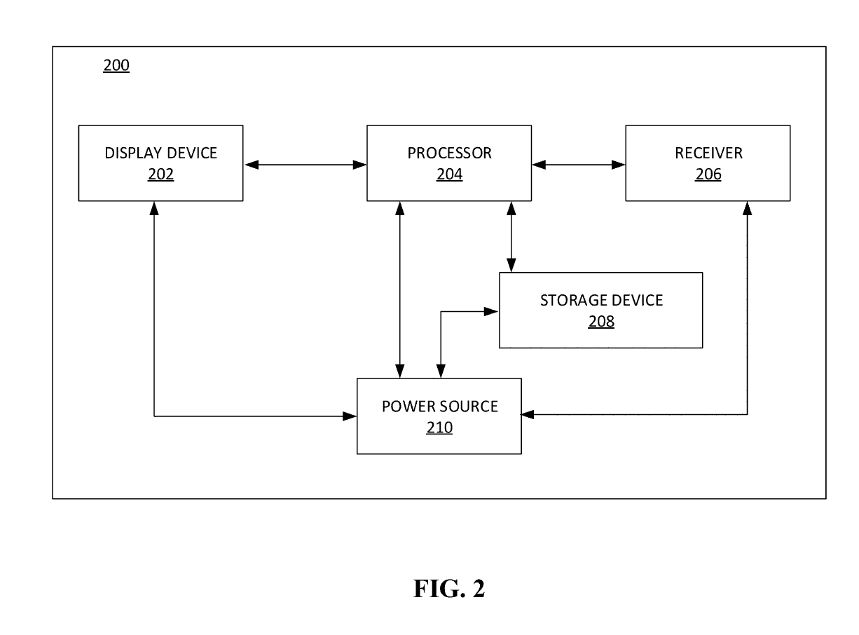

FIG. 2 shows a block diagram of a smart apparatus 200 for facilitating customizable display of images on a surface of an article. The smart apparatus 200 may include a display device 202 configured to be disposed on the surface of the article. Further, the display device 202 may include a plurality of display elements arranged according to a predetermined pattern. Further, the plurality of display elements may be configured for generating a plurality of light outputs based on a plurality of light activation signals. Further, the smart apparatus 200 may include a processor 204 communicatively coupled to the display device 202. Further, the processor 204 may be configured for processing a display data. In some embodiments, the display data may include the plurality of light activation signals. In other words, there may be no need for performing any further processing. Accordingly, the receiver 206 may be configured for directly receiving the plurality of light activation signals from the at least one user device. Further, the processor 204 may be configured for generating the plurality of light activation signals based on the processing. In some embodiments, the form of the display data may be more user friendly (e.g. natural language descriptions such as flash, color names, subjective/relative indication of intensity and so on) while the form of the plurality of light activation signals is more technical (i.e. light intensity levels, address of pixel etc.). Further, the smart apparatus 200 may include a receiver 206 communicatively coupled to the processor 204. Further, the receiver 206 may be configured for receiving the display data from at least one user device associated with the article over a wireless communication channel. Further, the smart apparatus 200 may include a storage device 208 communicatively coupled to the processor 204. Further, the storage device 208 may be configured for storing one or more of the display data and the plurality of light activation signals. Further, the smart apparatus 200 may include a power source 210 configured for providing electrical energy. Further, the power source 210 may be electrically coupled to each of the display device 202, the processor 204, the receiver 206 and the storage device 208.

In some embodiments, the wireless communication channel may include one or more of a near field communication channel, a short-range communication channel, such as Bluetooth, ZigBee, etc., a Wi-Fi communication channel, a cellular communication channel and a satellite communication channel. In some embodiments, the smart apparatus 200 may receive the display data from a cloud server through the Wi-Fi communication channel. Accordingly, users may be able to customize and control display of images on the article from anywhere in the world by logging on the cloud server through a mobile app on their respective user devices.

In some embodiments, the smart apparatus 200 may include an adhesive layer configured for attaching the smart apparatus 200 to the article. In an embodiment, the adhesive layer may include adhesive, clings, hooks, stitching, Velcro, and other attaching mechanisms for attaching the smart apparatus 200 to the article.

In some embodiments, the smart apparatus 200 may include a flexible panel configured for housing each of the display device 202, the processor 204, the receiver 206, the storage device 208 and the power source 210.

In some embodiments, the at least one user device may include a first user device associated with a first user and a second user device associated with a second user. Further, the first user may be a wearer of the article. Further, the second user may be socially connected to the second user. Further, the display data may include a first display data associated with the first user device and a second display data associated with the second user device. Further, the receiver 206 may be configured for receiving a first authentication code from the first user device. Further, the receiver 206 may be configured for receiving a second authentication code from the second user device. Further, the plurality of light activation signals may include a first plurality of light activation signals and a second plurality of light activation signals. Further, the processor 204 may be configured for generating the first plurality of light activation signals based further on the first authentication code and the first display data. Further, the processor 204 may be configured for generating the second plurality of light activation signals based further on the second authentication code and the second display data.

In some embodiments, the receiver 206 may be further configured for receiving at least one display restriction data from the first user device. Further, the processor 204 may be configured for generating the second plurality of light activation signals based further on the at least one display restriction data. Further, the storage device 208 may be configured for storing the at least one display restriction data. In an embodiment, a user may allow a friend to customize and control display data to be displayed on the smart article worn by the user, but within certain limitations. For example, the user may specify a description of content that may be objectionable to the user. Accordingly, in some embodiments, the processor 204 may be configured for analyzing each of the at least one display restriction and the display data corresponding to the user and/or the friend.

In some embodiments, the smart apparatus 200 may further include a transmitter communicatively coupled to the storage device 208. Further, the transmitter may be configured for transmitting one or more of the display data and the plurality of light activation signals to the at least one user device. For instance, a user may view the display patterns that are stored in the smart apparatus 200. These display patterns may have originated from the user and/or a friend of the user who was previously authorized to customize and control the smart apparatus 200.

In some embodiments, the display data may include at least one contextual display data. Further, the receiver 206 may be configured for receiving a display rule including an indication of at least one contextual parameter-value pair and the at least one contextual display data associated with the at least one contextual parameter-value pair. For instance, the user may define certain parameter-value pairs (e.g. location, time, state of motion etc.) and corresponding display data to be presented when values of those parameters are satisfied. Further, in some embodiments, the determination of these values may be performed by a mobile device of the user. In other embodiments, the smart apparatus 200 may include one or more sensors necessary to determine these values. Further, the storage device 208 may be configured for storing the display rule. Further, the processor 204 may be configured for determining at least one contextual parameter value. Further, the processor 204 may be configured for comparing the at least one contextual parameter value with the at least one contextual parameter-value pair. Further, the processor 204 may be configured for identifying the at least one contextual display data based on the comparing.

In some embodiments, the receiver 206 may be further configured for receiving the at least one contextual parameter value from the at least one user device. Further, the at least one user device may be configured for detecting the at least one contextual parameter value.

In some embodiments, the smart apparatus 200 may further include at least one sensor communicatively coupled to the processor 204. Further, the at least one sensor may be configured for detecting the at least one contextual parameter value.

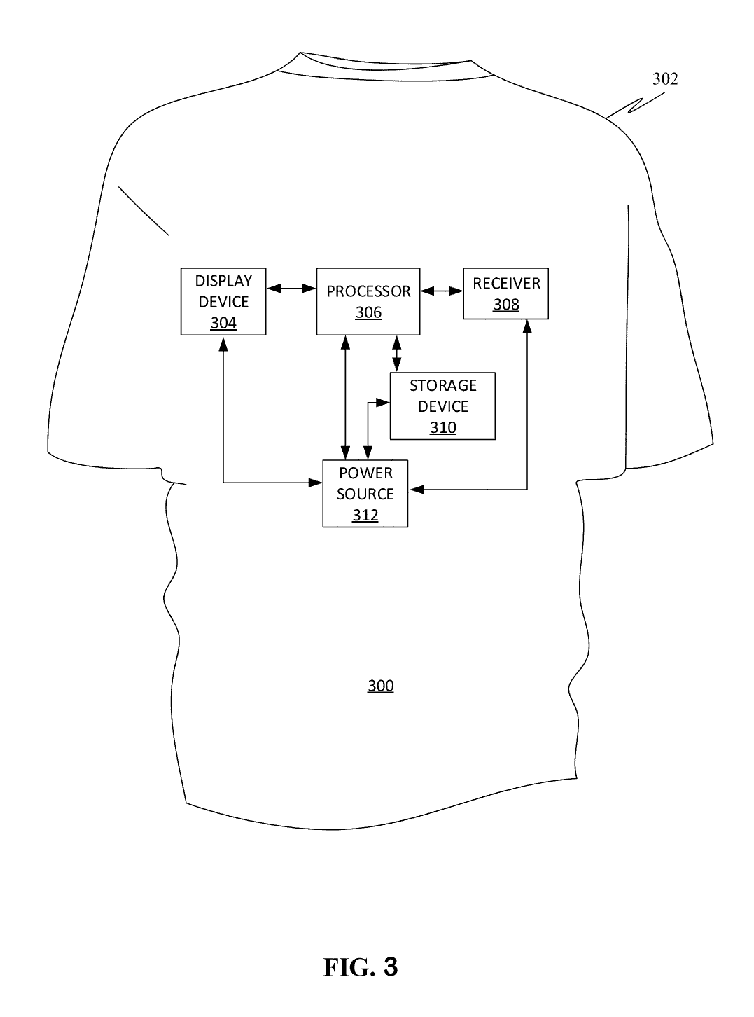

FIG. 3 shows a smart article 300 configured for providing a customizable display of light output. The smart article 300 may include a body 302. Further, the smart article 300 may include a display device 304 embedded in the body 302 of the smart article 300. In some instances, the embedding of the display device 304 in the body 302 may include disposing the display elements over a surface of the smart article 300. In other instances, the embedding of the display device 304 in the body 302 may include incorporating the display elements within an interior space of the body 302. Accordingly, in some instances, at least a portion of the body 302 of the smart article 300 may be transparent or translucent in order to facilitate passage of the light output to an external environment of the smart article 300.

Further, the display device 304 may include a plurality of display elements arranged according to a predetermined pattern. Further, the plurality of display elements may be configured for generating a plurality of light outputs based on a plurality of light activation signals. Further, the smart article 300 may include a processor 306 embedded in the body 302. Further, the processor 306 may be communicatively coupled to the display device 304. Further, the processor 306 may be configured for processing a display data. Further, the processor 306 may be configured for generating the plurality of light activation signals based on the processing. Further, the smart article 300 may include a receiver 308 embedded in the body 302. Further, the receiver 308, may be communicatively coupled to the processor 306. Further, the receiver 308, may be configured for receiving the display data from at least one user device associated with the smart article 300 over a wireless communication channel. Further, the smart article 300 may include a storage device 310 embedded in the body 302. Further, the storage device 310 may be communicatively coupled to the processor 306. Further, the storage device 310 may be configured for storing one or more of the display data and the plurality of light activation signals. Further, the smart article 300 may include a power source 312 embedded in the body 302. Further, the power source 312 may be configured for providing electrical energy. Further, the power source 312 may be electrically coupled to each of the display device 304, the processor 306, the receiver 308, and the storage device 310.

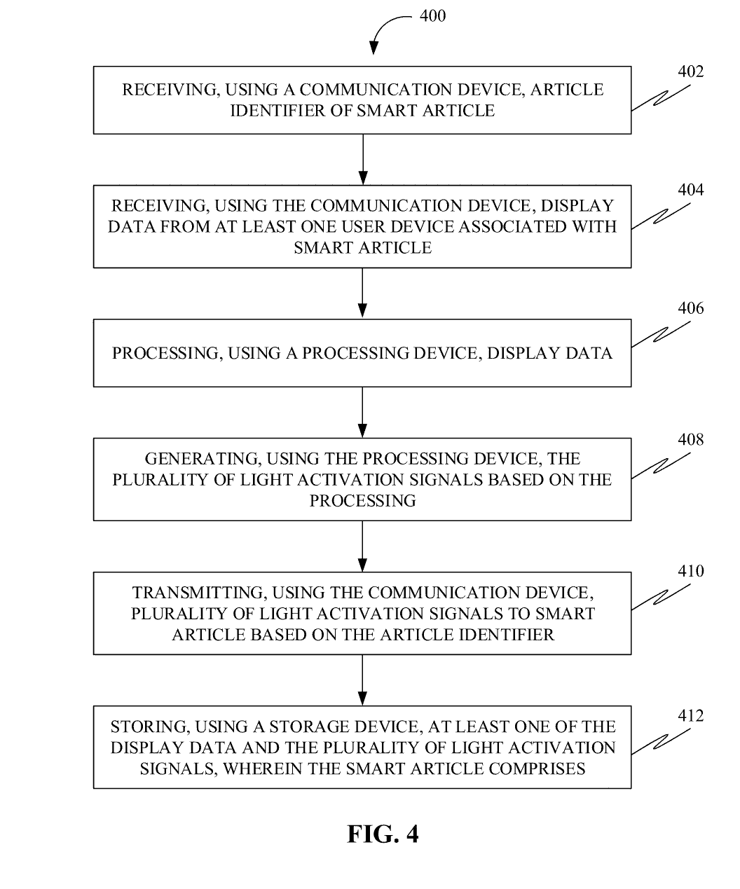

FIG. 4 shows a method 400 of facilitating customized display of images on a smart article. At 402, the method 400 may include receiving, using a communication device, such as the receiver 206, an article identifier of the smart article, such as the smart article 300.

Further, at 404, the method 400 may include receiving, using the communication device, display data from at least one user device associated with the smart article. In some embodiments, the smart article may include a smart wearable article. Further, the smart wearable article may include at least one of a garment, a shoe, a glove, a hat, a cap, an accessory, a piece of jewelry, spectacles, lingerie, a belt, and socks. In some embodiments, the smart article may include a smart sports equipment, such as for example, but not limited to, at least one of a skateboard, a snowboard, skis, and a bicycle.

Further, at 406, the method 400 may include processing, using a processing device, such as the processor 204, the display data.

Further, at 408, the method 400 may include generating, using the processing device, the plurality of light activation signals based on the processing.

Further, at 410, the method 400 may include transmitting, using the communication device, a plurality of light activation signals to the smart article based on the article identifier.

Further, at 412, the method 400 may include storing, using a storage device, such as the storage device 208, one or more of the display data and the plurality of light activation signals. Further, the smart article may include a body. Further, the smart article may include a display device embedded in the body of the smart article. Further, the display device may include a plurality of display elements arranged according to a predetermined pattern. Further, the plurality of display elements may be configured for generating a plurality of light outputs based on a plurality of light activation signals. Further, the smart article may include a processor embedded in the body. Further, the processor may be communicatively coupled to the display device. Further, the processor may be configured for processing a display data. Further, the processor may be configured for generating the plurality of light activation signals based on the processing. Further, the smart article may include a receiver embedded in the body. Further, the receiver may be communicatively coupled to the processor. Further, the receiver may be associated with the article identifier of the smart article. Further, the receiver may be configured for receiving the display data from at least one user device associated with the smart article over a wireless communication channel. Further, the smart article may include a storage device embedded in the body. Further, the storage device may be communicatively coupled to the processor. Further, the storage device may be configured for storing one or more of the display data and the plurality of light activation signals. Further, the smart article may include a power source embedded in the body. Further, the power source may be configured for providing electrical energy. Further, the power source may be electrically coupled to each of the display device, the processor, the receiver and the storage device.

In some embodiments, the method 400 may further include receiving, using the communication device, a permission data from the first user device. Further, the permission data may include an indication of one or more of a second user device of the at least one user device and a second user account associated with the second user device. Further, the second user device may be associated with a second user account socially connected with the first user account. Further, the receiving of the display data may include receiving a second display data from the second user device. Further, the generating of the plurality of light activation signals may include generating a second plurality of light activation signals based on the permission data. In some embodiments, the permission data may further include at least one display restriction data. Further, the generating of the second plurality of light activation signals may be based further on the at least one display restriction data. Further, the method 400 may include storing, using the storage device, the at least one display restriction data in association with the article identifier of the smart article.

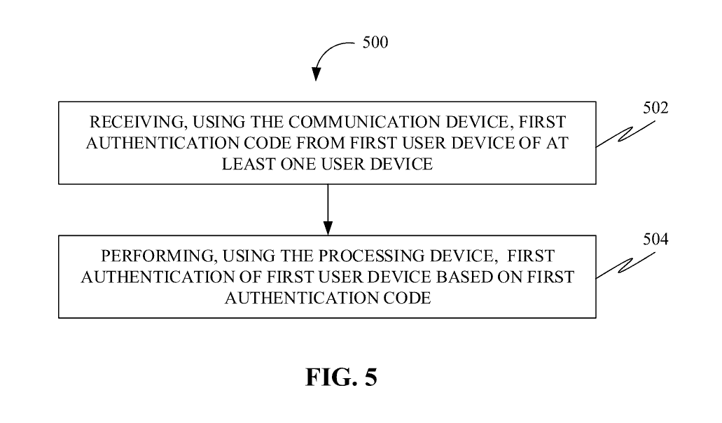

FIG. 5 shows a flowchart of a method 500 to perform a first authentication. Further, at 502, the method 500 may include receiving, using a communication device, a first authentication code from a first user device of the at least one user device. Further, the first user device may be associated with a first user.

Further, at 504, the method 500 may include performing, using a processing device, a first authentication of the first user device based on the first authentication code. Further, the generating of the plurality of light activation signals may include generating a first plurality of light activation signals based on the first authentication.

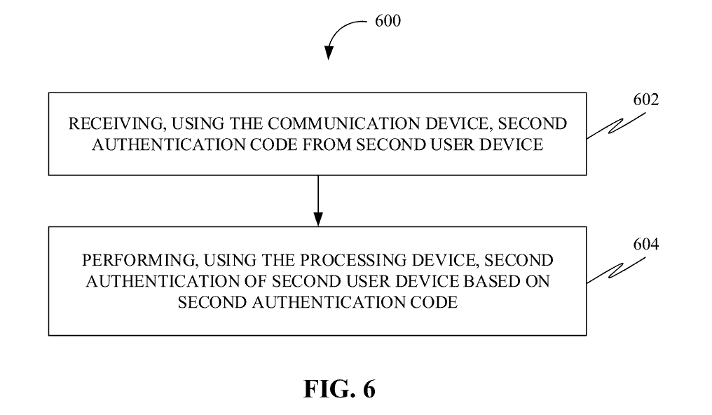

FIG. 6 shows a flowchart of a method 600 to perform a second authentication. In some embodiments, the permission data further may include a second authentication code. Further, at 602, the method 600 may include receiving, using the communication device, a second authentication code from a second user device.

Further, at 604, the method 600 may include performing, using the processing device, a second authentication of the second user device based on the second authentication code. Further, the generating of the plurality of light activation signals may include generating a second plurality of light activation signals based on the second authentication.

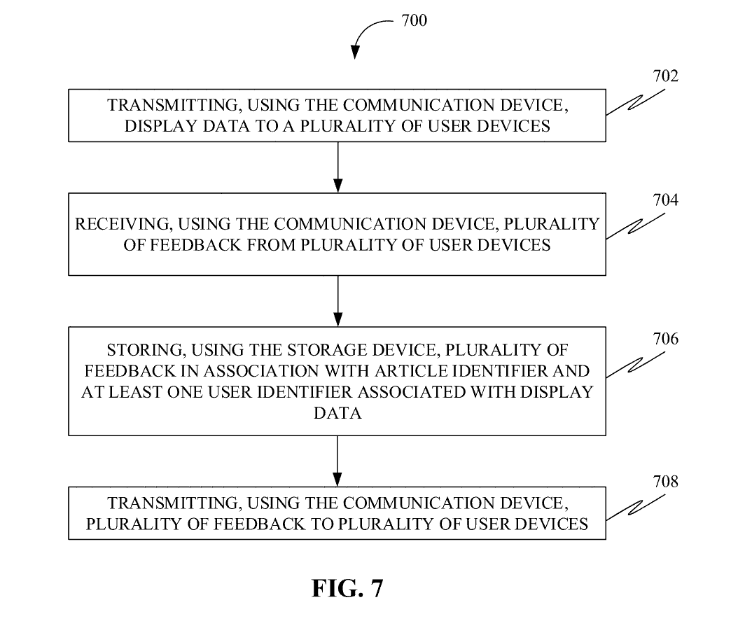

FIG. 7 shows a flowchart of a method 700 to transmit a feedback to a user device, in accordance with some embodiments. Further, at 702, the method 700 may include transmitting, using the communication device, the display data to a plurality of user devices.

Further, at 704, the method 700 may include receiving, using the communication device, a plurality of feedback from the plurality of user devices.

Further, at 706, the method 700 may include storing, using the storage device, the plurality of feedback in association with the article identifier and at least one user identifier associated with the display data.

Further, at 708, the method 700 may include transmitting, using the communication device, the plurality of feedback to the plurality of user devices.

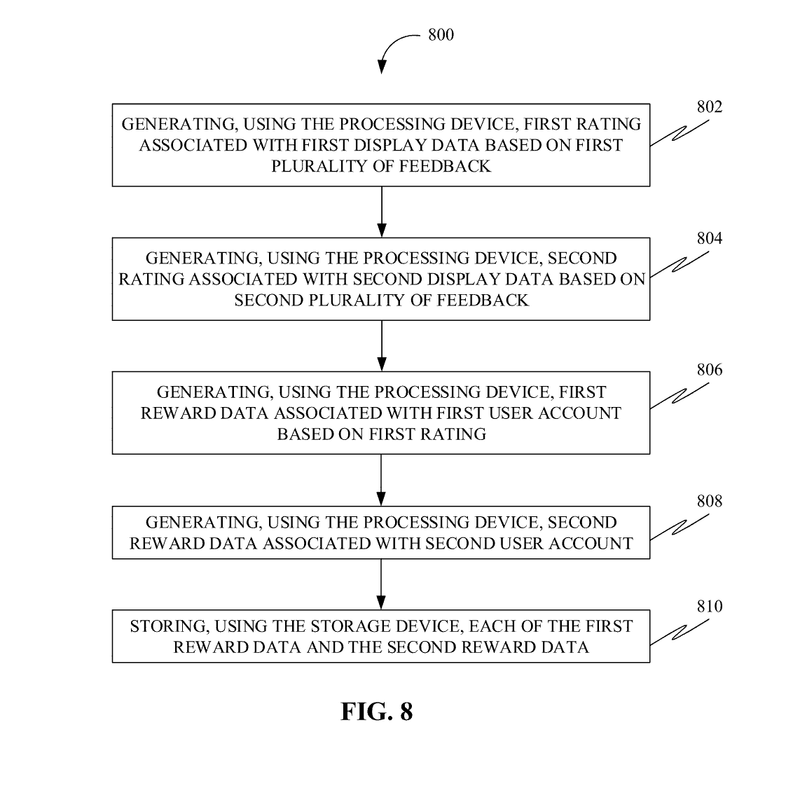

FIG. 8 shows a flowchart of a method 800 to generate reward data, in accordance with some embodiments. In some embodiments, the display data may include a first display data and a second display data. Further, the first display data may be received from the first user device. Further, the second display data may be received from the second user device. Further, the plurality of feedback may include a first plurality of feedback corresponding to the first display data and a second plurality of feedback corresponding to the second display data. Further, the at least one user identifier may include a first user identifier corresponding to the first user device and a second user identifier corresponding to the second user device. Further, at 802, the method 800 may include generating, using the processing device, a first rating associated with the first display data based on the first plurality of feedback.

Further, at 804, the method 800 may include generating, using the processing device, a second rating associated with the second display data based on the second plurality of feedback.

Further, at 806, the method 800 may include generating, using the processing device, a first reward data associated with the first user account based on the first rating. In some embodiments, the reward data may include cryptocurrency (e.g. Rockme Coin)

Further, at 808, the method 800 may include generating, using the processing device, a second reward data associated with the second user account.

Further, at 810, the method 800 may include storing, using the storage device, each of the first reward data and the second reward data.

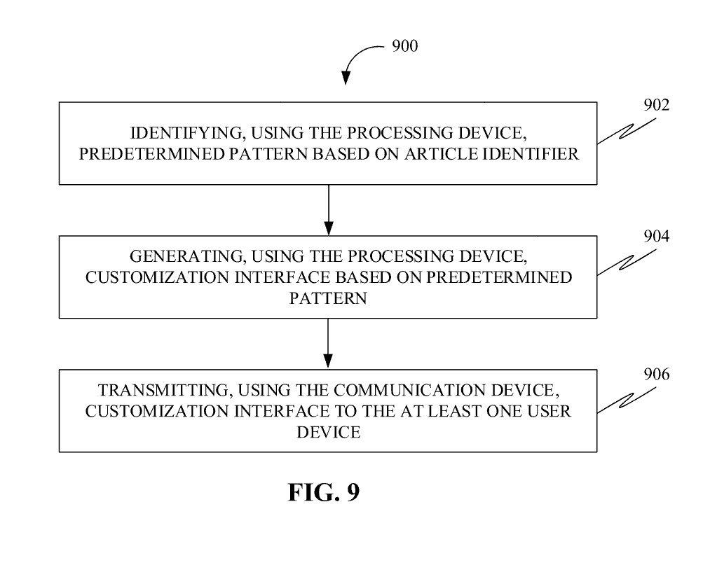

FIG. 9 shows a flowchart of a method 900 to generate a customization interface, in accordance with some embodiments. At 902, the method 900 may include identifying, using the processing device, the predetermined pattern based on the article identifier.

Further, at 904, the method 900 may include generating, using the processing device, a customization interface based on the predetermined pattern. Further, the customization interface may include a plurality of GUI elements corresponding to the plurality of display elements.

Further, at 906, the method 900 may include transmitting, using the communication device, the customization interface to the at least one user device. Further, the display data may include a plurality of selections corresponding to the plurality of GUI elements. Further, the at least one user device may include at least one input device configured for receiving the plurality of selections. Further, a selection corresponding to a GUI element may represent to at least one light output characteristic of a display element associated with the GUI element. For instance, a customization interface corresponding to a GUI for controlling pixel level light emission may be transmitted. Accordingly, characteristics such as color/frequency, intensity, flashing etc. may be selected at a pixel level using the GUI.

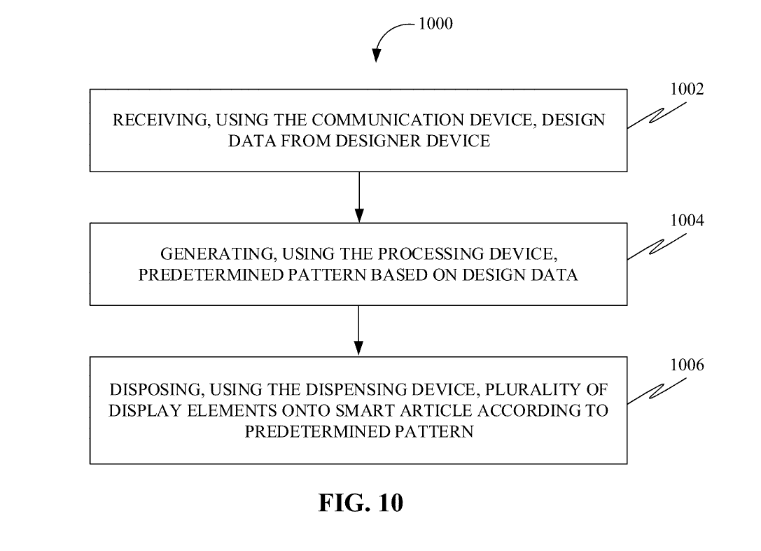

FIG. 10 shows a flowchart of a method 1000 to dispose a plurality of display elements onto a smart article, in accordance with some embodiments. Further, at 1002, the method 1000 may include receiving, using the communication device, a design data from a designer device. For instance, the method 1000 may include receiving theme based designs from designers according to which LED panel patterns are generated and embedded onto articles.

Further, at 1004, the method 1000 may include generating, using the processing device, the predetermined pattern based on the design data.

Further, at 1006, the method 1000 may include disposing, using a dispensing device, the plurality of display elements onto the smart article according to the predetermined pattern. For instance, in an embodiment, the method 1000 may include generating the customizable smart article by using a dispenser device for laying out the LEDs and/or the LED panel onto the smart article such as a smart clothing.

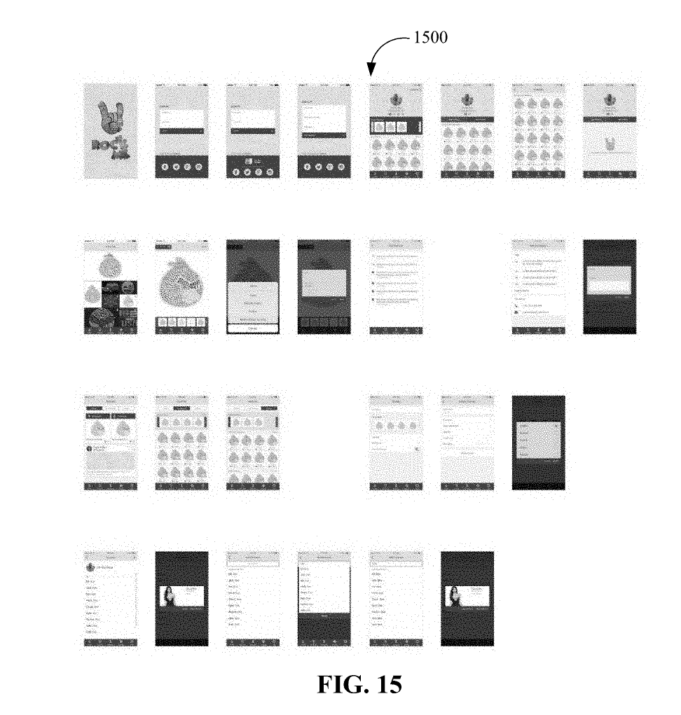

FIG. 15 shows an exemplary user interface 1500 of the RockMe™ application for iOS® that may allow a user to connect to a smart apparatus, such as the smart apparatus 200, or a smart article, such as the smart article 300.

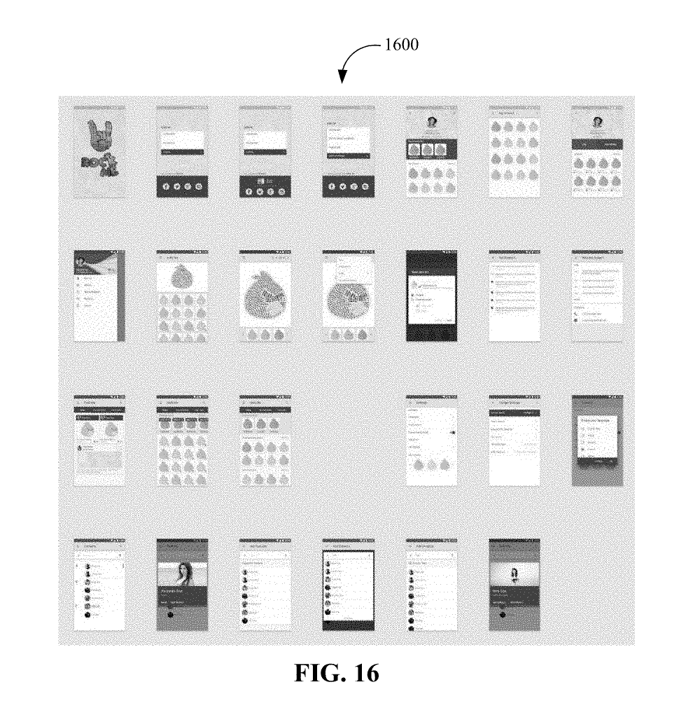

FIG. 16 shows an exemplary user interface 1600 of the RockMe™ application for Android® that may allow a user to connect to a smart apparatus, such as the smart apparatus 200, or a smart article, such as the smart article 300.

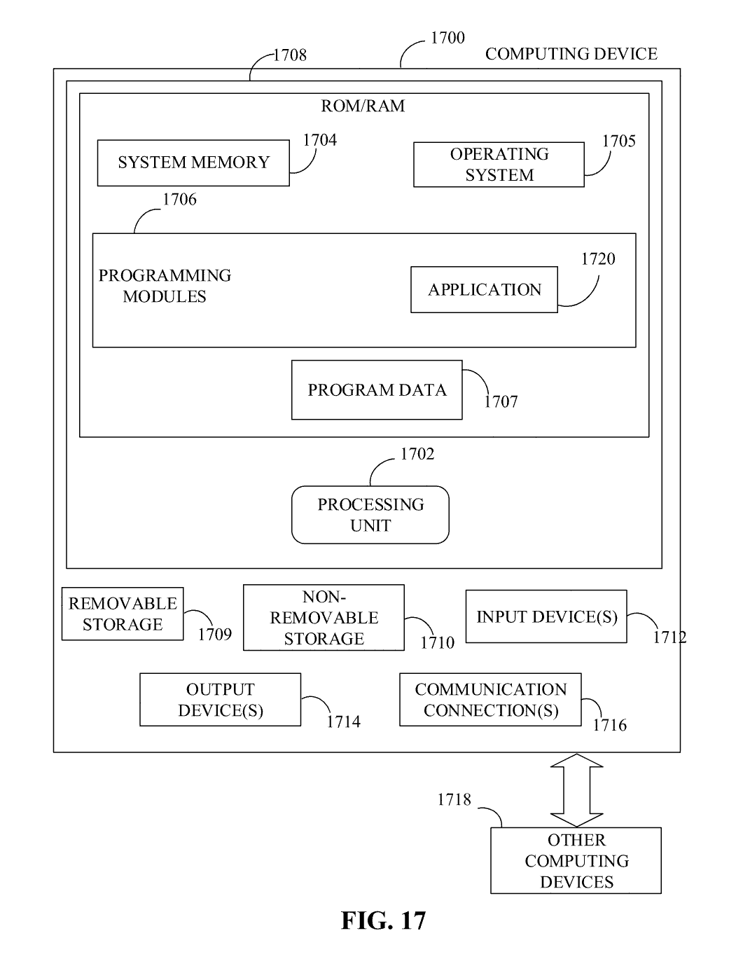

With reference to FIG. 17, a system consistent with an embodiment of the disclosure may include a computing device or cloud service, such as computing device 1700. In a basic configuration, computing device 1700 may include at least one processing unit 1702 and a system memory 1704. Depending on the configuration and type of computing device, system memory 1704 may comprise, but is not limited to, volatile (e.g. random-access memory (RAM)), non-volatile (e.g. read-only memory (ROM)), flash memory, or any combination. System memory 1704 may include operating system 1705, one or more programming modules 1706, and may include a program data 1707. Operating system 1705, for example, may be suitable for controlling computing device 1700's operation. In one embodiment, programming modules 1706 may include machine learning module. Furthermore, embodiments of the disclosure may be practiced in conjunction with a graphics library, other operating systems, or any other application program and is not limited to any particular application or system. This basic configuration is illustrated in FIG. 17 by those components within a dashed line 1708.

Computing device 1700 may have additional features or functionality. For example, computing device 1700 may also include additional data storage devices (removable and/or non-removable) such as, for example, magnetic disks, optical disks, or tape. Such additional storage is illustrated in FIG. 17 by a removable storage 1709 and a non-removable storage 1710. Computer storage media may include volatile and nonvolatile, removable and non-removable media implemented in any method or technology for storage of information, such as computer-readable instructions, data structures, program modules, or other data. System memory 1704, removable storage 1709, and non-removable storage 1710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1700. Any such computer storage media may be part of device 1700. Computing device 1700 may also have input device(s) 1712 such as a keyboard, a mouse, a pen, a sound input device, a touch input device, a location sensor, a camera, a biometric sensor, etc. Output device(s) 1714 such as a display, speakers, a printer, etc. may also be included. The aforementioned devices are examples and others may be used.

Computing device 1700 may also contain a communication connection 1716 that may allow device 1700 to communicate with other computing devices 1718, such as over a network in a distributed computing environment, for example, an intranet or the Internet. Communication connection 1716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1704, including operating system 1705. While executing on processing unit 1702, programming modules 1706 (e.g., application 1720 such as a media player) may perform processes including, for example, one or more stages of methods, algorithms, systems, applications, servers, databases as described above. The aforementioned process is an example, and processing unit 1702 may perform other processes. Other programming modules that may be used in accordance with embodiments of the present disclosure may include machine learning application.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the disclosure has been explained in relation to its preferred embodiment, it is to be understood that many other possible modifications and variations can be made without departing from the spirit and scope of the disclosure.

1. A smart apparatus for facilitating customizable display of images on a surface of an article, the smart apparatus comprising:
a display device configured to be disposed on the surface of the article, wherein the display device comprises a plurality of display elements arranged according to a predetermined pattern, wherein the plurality of display elements is configured for generating a plurality of light outputs based on a plurality of light activation signals;
a processor communicatively coupled to the display device, wherein the processor is configured for:
processing a display data; and
generating the plurality of light activation signals based on the processing;
a receiver communicatively coupled to the processor, wherein the receiver is configured for receiving the display data from at least one user device associated with the article over a wireless communication channel;
a storage device communicatively coupled to the processor, wherein the storage device is configured for storing at least one of the display data and the plurality of light activation signals; and
a power source configured for providing electrical energy, wherein the power source is electrically coupled to each of the display device, the processor, the receiver and the storage device.

2. The smart apparatus of claim 1, wherein the wireless communication channel comprises at least one of a near field communication channel, a short range communication channel, a Wi-Fi communication channel, a cellular communication channel and a satellite communication channel.

3. The smart apparatus of claim 1 comprising an adhesive layer configured for attaching the smart apparatus to the article.

4. The smart apparatus of claim 1 comprising a flexible panel configured for housing each of the display device, the processor, the receiver, the storage device and the power source.

5. The smart apparatus of claim 1, wherein the at least one user device comprises a first user device associated with a first user and a second user device associated with a second user, wherein the first user is a wearer of the article, wherein the second user is socially connected to the second user, wherein the display data comprises a first display data associated with the first user device and a second display data associated with the second user device, wherein the receiver is further configured for:
receiving a first authentication code from the first user device; and
receiving a second authentication code from the second user device, wherein the plurality of light activation signals comprises a first plurality of light activation signals and a second plurality of light activation signals, wherein the processor is configured for generating the first plurality of light activation signals based further on the first authentication code and the first display data, wherein the processor is configured for generating the second plurality of light activation signals based further on the second authentication code and the second display data.

6. The smart apparatus of claim 5, wherein the receiver is further configured for receiving at least one display restriction data from the first user device, wherein the processor is configured for generating the second plurality of light activation signals based further on the at least one display restriction data, wherein the storage device is further configured for storing the at least one display restriction data.

7. The smart apparatus of claim 1 further comprising a transmitter communicatively coupled to the storage device, wherein the transmitter is configured for transmitting at least one of the display data and the plurality of light activation signals to the at least one user device.

8. The smart apparatus of claim 1, wherein the display data comprises at least one contextual display data, wherein the receiver is further configured for receiving a display rule comprising indication of at least one contextual parameter-value pair and the at least one contextual display data associated with the at least one contextual parameter-value pair, wherein the storage device is further configured for storing the display rule, wherein the processor is further configured for:
determining at least one contextual parameter value;
comparing the at least one contextual parameter value with the at least one contextual parameter-value pair; and
identifying the at least one contextual display data based on the comparing.

9. The smart apparatus of claim 8, wherein the receiver is further configured for receiving the at least one contextual parameter value from the at least one user device, wherein the at least one user device is configured for detecting the at least one contextual parameter value.

10. The smart apparatus of claim 9 further comprising at least one sensor communicatively coupled to the processor, wherein the at least one sensor is configured for detecting the at least one contextual parameter value.

11. A smart article configured for providing customizable display of light output, the smart article comprising:
a body;
a display device embedded in the body of the smart article, wherein the display device comprises a plurality of display elements arranged according to a predetermined pattern, wherein the plurality of display elements is configured for generating a plurality of light outputs based on a plurality of light activation signals;
a processor embedded in the body, wherein the processor is communicatively coupled to the display device, wherein the processor is configured for:
processing a display data; and
generating the plurality of light activation signals based on the processing;
a receiver embedded in the body, wherein the receiver is communicatively coupled to the processor, wherein the receiver is configured for receiving the display data from at least one user device associated with the smart article over a wireless communication channel;
a storage device embedded in the body, wherein the storage device is communicatively coupled to the processor, wherein the storage device is configured for storing at least one of the display data and the plurality of light activation signals; and
a power source embedded in the body, wherein the power source is configured for providing electrical energy, wherein the power source is electrically coupled to each of the display device, the processor, the receiver and the storage device.

12. A method of facilitating customized display of images on a smart article, the method comprising:
receiving, using a communication device, an article identifier of the smart article;
receiving, using the communication device, display data from at least one user device associated with the smart article;
processing, using a processing device, the display data;
generating, using the processing device, a plurality of light activation signals based on the processing;
transmitting, using the communication device, the plurality of light activation signals to the smart article based on the article identifier; and,
storing, using a storage device, at least one of the display data and the plurality of light activation signals, wherein the smart article comprises:
a body;
a display device embedded in the body of the smart article, wherein the display device comprises a plurality of display elements arranged according to a predetermined pattern, wherein the plurality of display elements is configured for generating a plurality of light outputs based on a plurality of light activation signals;
a processor embedded in the body, wherein the processor is communicatively coupled to the display device, wherein the processor is configured for:
processing a display data; and
generating the plurality of light activation signals based on the processing;
a receiver embedded in the body, wherein the receiver is communicatively coupled to the processor, wherein the receiver is associated with the article identifier of the smart article, wherein the receiver is configured for receiving the display data from at least one user device associated with the smart article over a wireless communication channel;
a storage device embedded in the body, wherein the storage device is communicatively coupled to the processor, wherein the storage device is configured for storing at least one of the display data and the plurality of light activation signals; and
a power source embedded in the body, wherein the power source is configured for providing electrical energy, wherein the power source is electrically coupled to each of the display device, the processor, the receiver and the storage device.

13. The method of claim 12 further comprising:
receiving, using the communication device, a first authentication code from a first user device of the at least one user device, wherein the first user device is associated with a first user;
performing, using the processing device, a first authentication of the first user device based on the first authentication code, wherein the generating of the plurality of light activation signals comprise generating a first plurality of light activation signals based on the first authentication.

14. The method of claim 12 further comprising receiving, using the communication device, a permission data from the first user device, wherein the permission data comprises indication of at least one of a second user device of the at least one user device and a second user account associated with the second user device, wherein the second user device is associated with a second user account socially connected with the first user account, wherein the receiving of the display data comprises receiving a second display data from the second user device, wherein the generating of the plurality of light activation signals comprises generating a second plurality of light activation signals based on the permission data.

15. The method of claim 14, wherein the permission data further comprises a second authentication code, wherein the method further comprises:
receiving, using the communication device, the second authentication code from the second user device;
performing, using the processing device, a second authentication of the second user device based on the second authentication code, wherein the generating of the plurality of light activation signals comprise generating a second plurality of light activation signals based on the second authentication.

16. The method of claim 14, wherein the permission data further comprises at least one display restriction data, wherein the generating of the second plurality of light activation signals is based further on the at least one display restriction data, the method further comprising storing, using the storage device, the at least one display restriction data in association with the article identifier of the smart article.

17. The method of claim 12 further comprising:
transmitting, using the communication device, the display data to a plurality of user devices;
receiving, using the communication device, a plurality of feedback from the plurality of user devices; and
storing, using the storage device, the plurality of feedback in association with the article identifier and at least one user identifier associated with the display data; and
transmitting, using the communication device, the plurality of feedback to the plurality of user devices.

18. The method of claim 17, wherein the display data comprises a first display data and a second display data, wherein the first display data is received from the first user device, wherein the second display data is received from the second user device, wherein the plurality of feedback comprises a first plurality of feedback corresponding to the first display data and a second plurality of feedback corresponding to the second display data, wherein the at least one user identifier comprises a first user identifier corresponding to the first user device and a second user identifier corresponding to the second user device, wherein the processing device is further configured for:
generating a first rating associated with the first display data based on the first plurality of feedback;
generating a second rating associated with the second display data based on the second plurality of feedback;
generating a first reward data associated with the first user account based on the first rating;
generating a second reward data associated with the second user account; and
storing, using the storage device, each of the first reward data and the second reward data.

19. The method of claim 12 further comprising:
identifying, using the processing device, the predetermined pattern based on the article identifier;
generating, using the processing device, a customization interface based on the predetermined pattern, wherein the customization interface comprises a plurality of GUI elements corresponding to the plurality of display elements;
transmitting, using the communication device, the customization interface to the at least one user device, wherein the display data comprises a plurality of selections corresponding to the plurality of GUI elements, wherein the at least one user device comprises at least one input device configured for receiving the plurality of selections, wherein a selection corresponding to a GUI element represents to at least one light output characteristic of a display element associated with the GUI element.

20. The method of claim 12 further comprising:
receiving, using the communication device, a design data from a designer device;
generating, using the processing device, the predetermined pattern based on the design data; and
disposing, using a dispensing device, the plurality of display elements onto the smart article according to the predetermined pattern.
